(19) United States
(12) Patent Application Publication
(10) Pub. No.: US 2001/0056540 A1
(43) Pub. Date: Dec. 27, 2001

(54) SECURE MEMORY AREA

(76) Inventors: TIMOTHY OBER, ATKINSON, NH (US); PETER REED, BEVERLY, MA (US)

Correspondence Address: GERALD T BODNER, HOFFMANN & BARON, LLP, 6900 JERICHO TURNPIKE, SYOSSET, NY, 11791

(21) Appl. No.: 09/154,300

(22) Filed: Sep. 16, 1998

Related U.S. Application Data
(60) Provisional application No. 60/059,082, filed on Sep. 16, 1997.
(60) Provisional application No. 60/059,840, filed on Sep. 16, 1997.

(51) Int. Cl. G06F 12/14

(52) U.S. Cl. 713/193

(57) ABSTRACT

A hardware secure memory area includes one or more secondary communication buses connected to a main communication bus. The secondary communication buses are coupled to the main communication bus by separate bus transceivers. The bus transceivers provide isolation between the communication buses and between unaccessed secondary buses and the main communication buses. Various external devices, such as memories, may be coupled to the communication buses. Only one bus transceiver may be activated at a time, thus making it impossible for two secondary communication buses to be linked.

### CROSS-REFERENCE TO RELATED PATENT APPLICATIONS

This application is based on U.S. Provisional Application Serial No. 60/059,082, filed Sep. 16, 1997 and U.S. Provisional Application Serial No. 60/059,840, filed Sep. 16, 1997, and is related to concurrently filed U.S. Application entitled “Cryptographic Co-Processor”, the disclosures of which are incorporated herein by reference.

### BACKGROUND OF THE INVENTION

1. Field Of The Invention

The present invention relates generally to a secure memory area, and more particularly relates to a secure area of memory with multiple communication buses having hardware that prevents unauthorized access to each communication bus.

1. Description Of The Prior Art

Application programs and data stored within a memory circuit are typically protected by an operating system software, if protected at all. The software allocates memory to an application program and prevents the application program from executing instructions outside the allocated memory space. Preventing application programs from exiting the designated memory space indirectly creates a secure environment within the memory circuit.

Software memory protection is not entirely secure because there is no hardware to physically block access to a particular area of memory. With software memory protection, it is possible have private data or encryption algorithms sharing a memory device with public information. Even though software protection isolates memory space between two application programs, it remains physically possible to access the private information.

### OBJECTS AND SUMMARY OF THE INVENTION

It is an object of the present invention to provide a secure memory area for storage of cryptographic keys, algorithms and data having security hardware that prevents unauthorized access to each storage area.

A secure memory area constructed in accordance with one form of the present invention includes a main communication bus circuit and one or more separate secondary memory bus circuits. The main communication bus circuit and secondary bus circuits, and any related memory circuits, are preferably formed on a single monolithic integrated circuit (chip). The secondary memory bus circuits preferably include a key bus circuit. The key bus circuit is provided for isolating a secret key storage area from the external world (i.e., anything outside the chip, for example, commands from an unauthorized accessor). This eliminates the possibility of accidentally leaking secret key material to the outside world. Another preferred secondary bus circuit is a cryptographic algorithm bus circuit. The cryptographic algorithm bus circuit is provided to eliminate the risk of an outside source from accessing cryptographic algorithms stored in a memory circuit coupled to the cryptographic algorithm bus circuit such as via an external memory bus circuit. A third preferred secondary bus circuit is the external memory bus circuit which has coupled to it one or more external memories (for storage of application programs, for example). Bus transceivers are coupled between each individual secondary communication bus and the main communication bus. Security is established by providing separate secondary communication buses for public and private information.

### BRIEF DESCRIPTION OF THE DRAWINGS

FIG. 1 is a block diagram of a secure cryptographic memory area formed in accordance with the present invention.

### DETAILED DESCRIPTION OF THE PREFERRED EMBODIMENTS

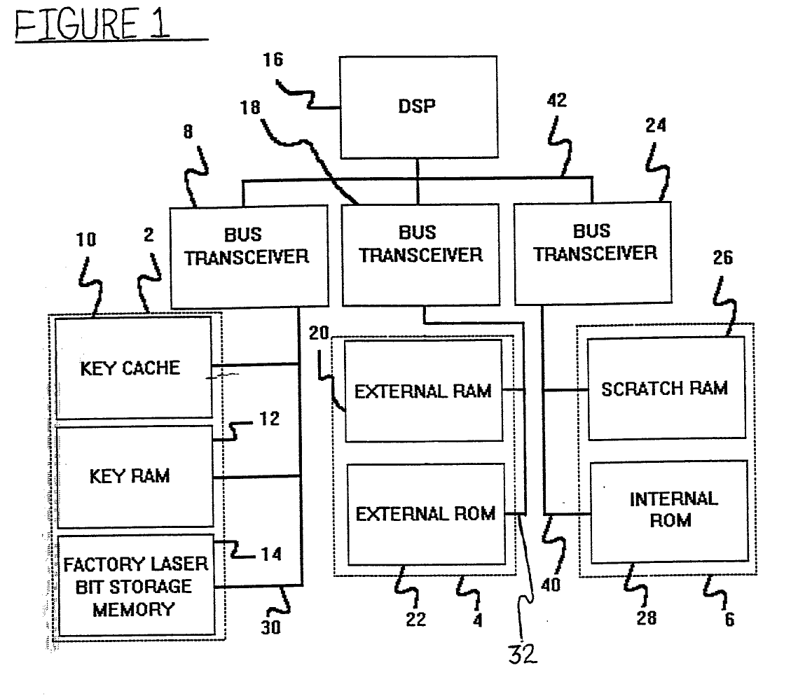

A block diagram of the secure cryptographic memory area formed in accordance with the present invention is illustrated in FIG. 1. The secure memory area preferably has three sections: key memory 2, external memory 4, and internal memory 6.

A first bus transceiver 8 is coupled to a key bus circuit 30. The first bus transceiver 8 controls access between the key bus circuit 30 and a main bus circuit 42. The key bus circuit 30 is coupled to a key random access memory (RAM) 12, a key cache memory 10, and a factory laser bit storage memory 14. The factory laser bit storage memory 14 stores a unique factory set variable used to encrypt keys. The first bus transceiver 8 is coupled between the main bus circuit 42 and the key bus circuit 30. This isolates the key bus circuit 30, and all memories and sections connected thereto, from the main bus circuit 42. A separate bus circuit ensures that when encryption services are operating on memory circuits coupled to the key bus circuit 30, data (e.g. a secret key) cannot be leaked to the external memory 4. This is prevented by having the external memory 4 on a separate external memory bus circuit 32. Access to the external memory bus circuit 32 is controlled by a second bus transceiver 18, which cannot be activated at the same time that the first bus transceiver 8 is activated.

The key RAM 12 provides a public key volatile storage area. The key RAM 12 has enough space to accommodate the private portion of at least one active public key operation. The key RAM 12 can not be read by an external application because, while the external memory 4 is being accessed, the first bus transceiver 8 blocks access to the key RAM 12.

The key cache memory 10 allows the application to access preferably up to 15 volatile secret key cache memory locations in which are stored various encryption keys. Each key cache location is preferably 30 words in length. The external application can not directly read the key cache memory 10 because of the bus isolation provided by the first bus transceiver 8.

The external memory bus circuit 32 couples an external RAM 20 and an external read only memory (ROM) 22 to the main bus 42 through the second bus transceiver 18. The second bus transceiver 18 controls access to the external memory bus circuit 32 from the main bus circuit 42. Having a separate external memory bus circuit 32 is important because, while the outside world is accessing the main bus circuit 42, the first bus transceiver 8 prevents access to the key bus circuit 30 and the secure key data stored in memory.

A third bus transceiver 24 controls access between the main bus circuit 42 and a cryptographic algorithm bus circuit 40. The cryptographic algorithm bus circuit 40 couples a scratch RAM 26 and an internal ROM 28 to the third bus transceiver 24. A separate bus is provided to prevent secure data and algorithms from being accessed by an external source via the external bus circuit 32. An external application can not read the internal ROM 28 because the third bus transceiver 24 is deactivated when the second bus transceiver 18 is activated. The third bus transceiver 24 is also deactivated when the first bus transceiver 8 is activated.

External RAM 20 is used to store application software for use by a processor. Encryption algorithms are stored in the internal ROM 28. Commands are passed back and forth between ROM 28 (encryption kernel) and the application via the external RAM 20. When the processor is accessing the external memory bus circuit 32, it is not possible to access the internal ROM 28 because it is isolated by the third bus transceiver 24. This prevents an external device, such as an emulator, from accessing the internal ROM 28 and reading the secure algorithms.

A small scratch RAM 26 exists for the encryption kernel and the cryptographic services to use as a storage device for intermediate calculations. The scratch RAM 26 is isolated from the external applications by the third bus transceiver 24.

The main communication bus 42 is coupled to a digital signal processor (DSP) 16, which internally includes a microprocessor. The microprocessor of the DSP 16 preferably communicates with and controls the activation and deactivation of the bus transceivers 8, 18, 24 by sending control signals to each transceiver. The DSP 16 ensures that only one transceiver will be active at any given time.

Hardware protection eliminates the possibility of compromising private algorithms or data. Isolating memory circuits and external devices with separate communication buses increases security and lowers the risk of accidentally releasing private information. Structuring memory around separate communication buses and permitting only one communication bus to be accessed at a time provides hardware security that exceeds that provided by software.

Although illustrative embodiments of the present invention have been described with reference to the accompanying drawing, it is to be understood that the invention is not limited to those precise embodiments, and that various other changes and modifications may be effected by one skilled in the art without departing from the scope or spirit of the invention.

What is claimed is:

1. A hardware secure memory area, which comprises:
a main communication bus;
a plurality of secondary communication buses;
a plurality of bus transceivers coupling the plurality of secondary communication buses to the main communication bus; and
a plurality of memory circuits coupled to the plurality of communication buses, each bus transceiver selectively isolating a secondary communication bus to which the bus transceiver is associated from the main communication bus and selectively causing communication between the associated secondary communication bus and the main communication bus.

2. A hardware secure memory area, which comprises:
a main communication bus;
a first bus transceiver coupled to the main communication bus;
a second bus transceiver coupled to the main communication bus;
a third bus transceiver coupled to the main communication bus;
a key communication bus coupled to the first bus transceiver;
a key cache coupled to the key communication bus for writing and reading keys;
a key random access memory coupled to the key communication bus for writing and reading cryptographic operations and keys;
a processor memory for writing and reading cryptographic algorithms, operations and keys;
an external memory communication bus coupled to the second bus transceiver;
an external memory coupled to the external memory communication bus for writing and reading application programs and commands;
a cryptographic algorithm communication bus coupled to the third bus transceiver;
a scratch memory coupled to the cryptographic algorithm communication bus for writing and reading cryptographic calculations; and
a memory coupled to the cryptographic algorithm communication bus for storing cryptographic algorithms.

3. A hardware secure memory area, which comprises:
a main communication bus;
a plurality of bus transceivers coupled to the main communication bus for controlling access to and from the main communication bus;
a plurality of secondary communication buses coupled to the bus transceivers; and
a plurality of memory circuits coupled to the plurality of secondary communication buses.
